(19) United States
(12) Patent Application Publication
(10) Pub. No.: US 2016/0033986 A1
(43) Pub. Date: Feb. 4, 2016

(54) SYSTEMS AND METHODS TO MANAGE RENEWABLE ENERGY ON THE ELECTRIC GRID

(71) Applicant: MELROK, LLC, Reno, NV (US)

(72) Inventors: Michel Roger Kamel, Buena Park, CA (US); Paul W. Donahue, Newport Coast, CA (US); Jeffrey Alan Dankworth, Reno, NV (US)

(21) Appl. No.: 14/812,924

(22) Filed: Jul. 29, 2015

Related U.S. Application Data
(60) Provisional application No. 62/030,757, filed on Jul. 30, 2014.
(60) Provisional application No. 62/148,065, filed on Apr. 15, 2015.

(51) Int. Cl. G05F 1/66; G05B 15/02

(52) U.S. Cl. CPC G05F 1/66; G05B 15/02

(57) ABSTRACT

Systems and methods use a platform to send communications and instructions to one or more distributed resources on the grid or microgrid or facility to direct a flow of power from one or more power sources to one or more energy consuming devices.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Our Information age society demands ever-increasing amounts of clean reliable renewable distributed energy supply and storage resources. To accomplish this, individual states, the U.S., and international bodies have embraced first-generation variable and intermittent “grid-tied” renewable energy resources, such as solar PV, wind, and storage to replace reliable but environmentally challenged, fossil fueled, and water-cooled thermoelectric power plants.

Congruent with society's goals and legislated mandates, today's electric energy system is incapable of meeting our growing demand for power without increasing strains on water supplies and increased climate change instabilities. The California Energy Commission, Public Utilities Commission, and grid operator “CAISO” have stated that the grid is currently at risk of failure with “substantial potential for serious public health and safety impacts.”

Therefore, we now are at a critical point in the transition from environmentally challenged thermoelectric power generation to higher percentages of renewable distributed energy supply and energy storage resources. We can no longer continue to rely solely on our environmentally challenged centralized base load and spinning reserve peaker plants for our critical energy resources at a time when first-generation “grid-tied” renewables have reached their maximum penetration in bellwether states such as Hawaii.

The limitations of first-generation grid-tied renewable energy supply and storage technologies mount a significant technical challenge to meet legislated goals of 40% or more energy from clean renewable energy resources while maintaining stable and reliable energy supplies on the grid. Societal goals of 100% renewable energy are further removed from reality with first-generation grid-tied renewables and storage.

### SUMMARY

Our society requires the rapid deployment of a second-generation renewable distributed energy supply and energy storage assessment, management, and payment system that is fully synchronized with a synchronized energy load management and payment system.

This requires a change in thinking to accommodate hundreds or thousands or millions of unpredictable, uncontrolled, and variable energy supplies, energy storage, and widely diverse types of energy loads from existing loads and new plug in electric or hybrid vehicle loads. The embodiments described herein provide distributed renewable energy management technologies, methodologies, and devices to enable the rapid growth, reliable deployment, and new business models for high percentage clean distributed renewable energy resources and distributed energy storage.

Energy efficiency technologies effectively offset or shift demand for energy at certain times of the day. Industry thought leaders characterize this dynamic reduction in facility energy demand plus the increasing amounts of distributed renewable energy as the “death spiral” for existing utility business models. Traditional Return-on-Equity and Cost-of-Service business models will not be viable.

Grid-tied solar PV, wind, and distributed energy storage interconnection technology brings clean renewable energy to the grid or a microgrid. Advantageously, the first-generation “grid-tied” renewable energy interconnection technology enables US states and regions to quickly lower greenhouse gas (GHG) emissions by replacing some portion of their fossil fueled and water-cooled electric energy generation with clean renewable energy.

The first-generation renewable interconnection technology directly connects highly variable, intermittent, and unbuffered renewable energy resources directly onto the electric grid without any intervening intelligence or control of energy supplies or loads. Intermittent renewable energy production can result in a substantial surplus of electricity supply during the early afternoon, and a significant deficit in the late afternoon. Smart Inverters such as described in IEEE 1547.8 and entering the market offer some promise for controlling solar PV energy onto the grid but they lack a cohesive control, management, and directivity technology to direct or control the flow of solar energy from one or more panels to be stored, used locally, or to feed the grid in any increment from 0-100% of the locally generated capacity.

In general, systems become increasing unstable when influenced by increasing variability's and instabilities. A simple maxim is the more uncontrolled variability in the form of either undersupply or oversupply introduced directly onto the energy grid with “grid-tied” solar PV, wind, or distributed storage, the more unstable and unreliable the energy grid will become. These renewable resources need to be managed across the grid in real time for a stable and reliable grid.

The disadvantage of first-generation renewable “grid-tied” energy technology arises by directly introducing increased levels of variability and intermittency onto our critical electric energy power grid. In some embodiments, grid instability and unreliability begins to occur when an estimated 15-20% of energy is supplied by first-generation grid-tied renewable energy supplies. First-generation “grid-tied” renewable energy delivers both uncontrolled oversupply and undersupply at different times of the day. One might think that this has little consequence. However, for the grid to be stable, supply (S) and demand/load (D) should be approximately equally matched or identically matched approximately 60 times per second. S=D/60 times per second becomes the new paradigm for introducing renewable solar and wind onto the grid.

This energy supply and loading balance was once accomplished through management of a few centralized load-following fossil-fueled and water-cooled thermoelectric “spinning reserve” or “pecker” power plants. Historically, frequency of generation and load-following output from a few centralized power plants are the rudimentary elements to reliably supplement basic thermoelectric energy generation.

These first generation grid-tied renewable energy technologies are installed, and operated under guidelines established in the IEEE-1547 Standard for connecting distributed energy to the grid. In the US, the National Electrical Codes (NEC) also provide guidelines for and influence local solar and wind construction and interconnection permitting processes. From IEEE 1547: “Traditionally, utility electric power systems (EPS-grid or utility grid) were not designed to accommodate active generation and storage at the distribution level. As a result, there are major issues and obstacles to an orderly transition to using and integrating distributed power resources with the grid.”

The intermittent variability of energy supply from first-generation “grid-tied” solar PV system directly imprints its instability, intermittency, or variability of both undersupply and oversupply of energy supply directly onto the grid. This condition, unmanaged or uncontrolled, is multiplied by higher percentages of distributed grid energy can destabilize the grid and compromise the value of all electrical devices connected thereto.

This variability in energy supply overwhelm the existing electric grid's level of intelligence and control to follow and meet energy load demands when renewable contributions exceed approximately 15-20% in some embodiments. Hawaii is considered the bellwether U.S. leader in the quest for high levels of clean renewable energy onto the grid. At 22.6% of clean renewable direct grid-tied solar energy, Hawaii has reached the limits of first-generation renewables at just over ½ of Hawaii's goals of 40% clean renewable energy by 2030. Currently to maintain grid reliability and stability, Hawaii will not permit the interconnection of any additional first-generation grid-tied solar PV systems.

There also is a mounting concern from utilities and experts that large, new, unpredictable energy loads on the grid from increased use of plug-in electric vehicles may further destabilize the grid without an intervening second-generation “grid-tied” technology. This is particularly a concern where high percentages of variable first-generation grid-tied solar and wind energy resources are in place.

Fossil fueled, water-cooled energy supply can no longer be counted on to fill the variable needs of demand on the grid or a micro grid in a low carbon and environmentally sustainable resilient manner. Instead, energy demand and distributed energy supplies must be assessed, forecasted, synchronized, managed, and controlled on a real time basis to insure a reliable and stable grid or micro grid.

Now with increased levels of distributed solar PV, distributed energy storage, and distributed wind supplies, embodiments of a new and novel level of grid monitoring, assessment, synchronization, and control described herein manages distributed renewable generation, distributed energy storage, and energy loads approximately 60 times per second.

The application of embodiments of technologies, methodologies, and devices described herein enable regulators and utilities to insure the rapid increase in renewable distributed energy supply and distributed energy storage to meet distributed energy load requirements that are fully in alignment with society's goals and legislated mandates.

To insure a reliable and stable source of clean renewable energy for our information age economy, energy management technologies described herein synchronize intermittent renewable energy sources from distributed locations with fast dynamic load management systems and centralized nonrenewable power generation.

The methods, devices, and big data cloud systems and processes described herein can effectively assess, forecast, and manage intermittent renewable energy supply and its variability to avoid energy interruptions (brownouts and blackouts) from under or over supply to reliably power our homes, businesses, and information age economy.

Without active management and synchronization of first-generation “grid-tied” renewable energy, we face increased uncertainty of energy supplies and stability issues on the grid. Uncertainty of supply from renewables comes in the form of variability or intermittency of supply in terms of amounts of energy available at any given time to stabilize grid loads. The worst case of first-generation “grid-tied” renewables occurs when excessive renewable energy supply levels begin to impede base energy operations and wreak havoc on load following energy production systems. The solution to this is proposed herein as second-generation “grid-tied” renewable assessment, forecasting, management, and control. A corollary big data cloud based system is also described herein.

Embodiments relate to systems and methods to use a platform to send communications and instructions to one or more distributed resources on the grid or microgrid or facility to direct a flow of power from one or more power sources to one or more energy consuming devices.

Some embodiments comprise a novel “grid-tied” renewable energy networking and management system coupled with wide area real time demand management. The grid-tied renewable energy networking and management system comprises real time streaming energy data and massively parallel big data cloud processing for analysis, forecasting, synchronization, management, and control through new Internet of Things device control technologies. The proposed solution represents a path to achieve legislated and environmental energy goals in the U.S. and the world.

Some embodiments of these advanced “grid-tied” renewable energy management and control technologies exhibit extremely low latency times from data input to assessment, forecasting, and concurrent control of widely dispersed renewable energy supplies, energy storage, and energy loads including Electric Vehicles or hybrid Electric Vehicles to be successful.

Some embodiments of the novel clean renewable energy interconnection technologies can deliver the largest percentage of clean renewable energy supplies on the grid and are comprised of one or more of:

1) Streaming, secure, open source energy data assessment and reporting to the big data cloud database from each point of distributed renewable energy supply or distributed energy storage;

2) Streaming open source energy load data to the big data cloud database from connected facilities and loads;

3) Fast big data parallel cloud processing (assessment, forecasting, analytics, and management/control strategies);

4) Fast, secure, wide-area energy supply, storage, and load management;

5) Concurrent automated method of billing for renewable energy supplies or storage;

6) Concurrent automated method of payment for powering distributed connected energy loads; and

7) Carbon assessment and trading network.

Some embodiments of the novel clean renewable energy interconnection technologies can:

1) Meet the increasing needs for reliable, renewable, clean energy;

2) Improve the stability and reliability of the grid with increasing amounts of clean renewable distributed solar, wind and storage;

3) Reduced climate change emissions, lower environmental harm, improved population health, reduced peak demand, greater grid resilience, greater reliability, and lessened susceptibility to power outages; and

4) Reduced reliance on fossil fueled and water-cooled thermoelectric power plants.

In an embodiment, the utility of the future can automatically assess, direct, and network distributed renewable energy suppliers and customers with the reliable, clean energy resources that our society requires for a sustainable future.

For purposes of summarizing the disclosure, certain aspects, advantages, and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates an embodiment of a cloud-controlled “grid-tied” facility level solar photovoltaic (PV) system without energy storage.

FIG. 2 illustrates an embodiment of a plurality of “grid-tied” facility level solar PV systems, where energy storage is installed at the site of local solar PV installation and aggregated at the grid substation or micro grid level.

FIG. 3 illustrates a circuit arrangement for a cloud based pulse-width modulation (PWM) or pulse-duration modulation (PDM) energy storage controller to control the output of a renewable energy generations system, such as a solar PV, wind, or energy storage system, according to certain embodiments.

FIG. 4 illustrates an exemplary block diagram of an energy device controller for real time continuous and automated measurement of energy use, analysis of energy use, control of energy use, and communication of energy use, energy quality, and metrics, according to certain embodiments.

### DETAILED DESCRIPTION

The features of the systems and methods will now be described with reference to the drawings summarized above. Throughout the drawings, reference numbers are re-used to indicate correspondence between referenced elements. The drawings, associated descriptions, and specific implementation are provided to illustrate embodiments of the inventions and not to limit the scope of the disclosure.

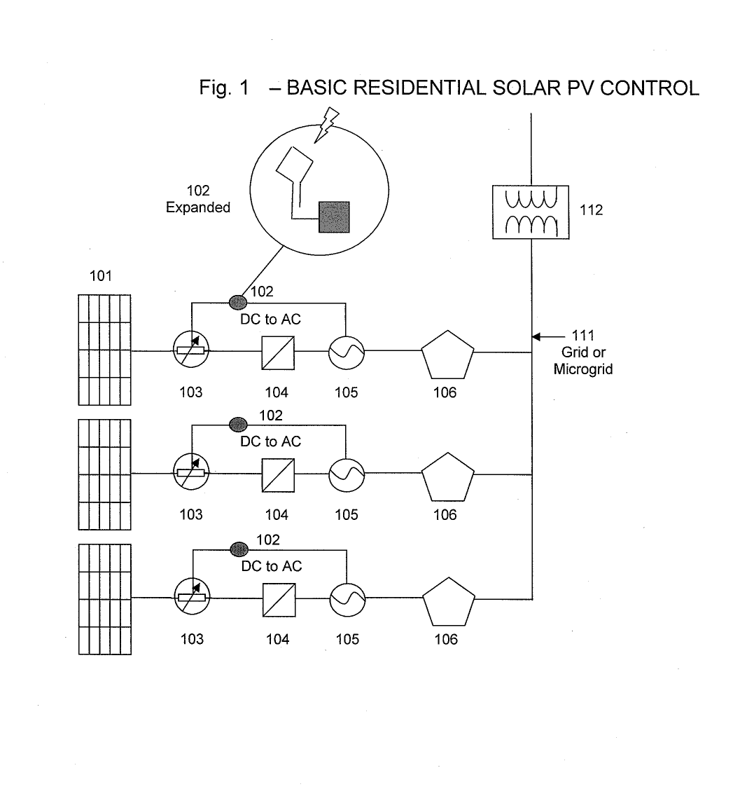

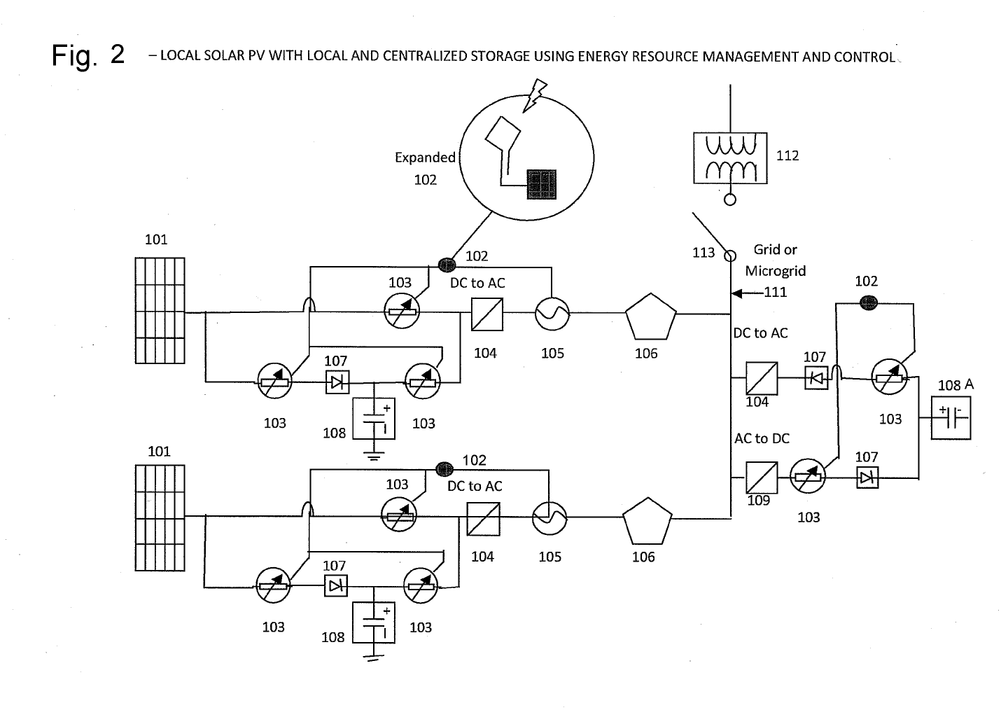

FIGS. 1 and 2 illustrate embodiments of residential PV modulation systems configured to address one or more of the following energy markets: automated demand response; demand shifting or load curve flattening; frequency regulation; and voltage stability.

### Grid-Tied Residential Solar PV Control

FIG. 1 illustrates an embodiment of a cloud-controlled “grid-tied” facility level solar PV system without energy storage. One or more solar PV panels 101 supply DC solar PV energy. Energy device controller 102 is used to control the amount of solar PV energy that is delivered in a “grid-tied” manner to facilities 106 or to the grid or micro grid 111. In an embodiment, the energy device controller 102 comprises a MelRok touch device. In another embodiment, energy device controller 102 comprises a hardware receiver/controller. In another embodiment, the energy device controller 102 comprises a stand-alone controller that is embedded with one of more of a modulator, a PWM modulator, a power inverter, an AC to DC converter, a DC to AC converter, or the like.

Energy device controller 102 is configured to receive information from a “smart meter” or submeter(s) 105 and receive remote information supplied about grid or micro grid conditions such as but not limited to frequency, phase, voltage levels, connected energy loads, energy pricing, carbon assessment, energy required to power loads, and the like. Energy device controller 102 is operatively connected to solar PV, wind, or energy storage controller 103 to remotely or locally assess, vary, and control the amount of solar PV energy that is transmitted from the solar panels 101 that is directed to a DC to AC inverter or smart inverter 104 for conveyance of AC renewable energy into an associated residence or facility 106 or onto the grid or micro grid 111. In an embodiment, the solar PV, wind, or energy storage controller 103 uses high efficiency DC switching such as pulse-width modulation (PWM) or pulse-duration modulation (PDM). In an embodiment, the grid or microgrid 111 delivers power to another electrical grid. Transformer 112, which is also referred to as a power pig, is used to transform the energy provided by the grid or microgrid 111 in order to match the electrical characteristics of the receiving electrical grid.

Thus, energy device controller 102 determines and controls the amount of solar PV from one or more solar panels 101 that is converted to synchronous AC 105 (frequency, phase, and level) and delivered to the associated facility(s) 106 or to the grid or micro grid 111. Further, energy device controller 102 communicates with local energy assessment and cloud based energy assessment, forecasting, and control systems.

Residential Solar PV Control with Neighborhood and Centralized Storage and Islanding

FIG. 2 illustrates an embodiment of a neighborhood of “grid-tied” facility level solar PV systems, where energy storage is installed at the site of local solar PV installation and aggregated at the grid substation or micro grid level.

The embodiment of the local solar PV system illustrated in FIG. 2 is similar to the local PV system illustrated in FIG. 1 with the addition of local energy storage 108 and with the addition of aggregation. Energy device controllers 102 communicate with local energy assessment and with cloud energy assessment, forecasting, and control systems. The amount of solar PV that is directed to be stored in local storage 108 and used at a later time or for local use or conveyance onto the grid or micro grid 111 is determined by energy device controller 102 and its wired or wireless communication with local and cloud energy assessment, forecasting, and control. Steering diode 107 directs the flow of energy.

Controller devices 103 direct, based at least in part on control signals received from the energy device controller 102, the amount of solar PV energy that is delivered to local storage 108, fed directly to the DC to AC inverter or smart inverter 104 and delivered to one or more facilities 106, or delivered to the grid or micro grid 111 for immediate use or storage.

Further, controller devices 103 direct, based at least in part on control signals received from the energy device controller 102, the amount of solar PV energy that is converted from AC to DC by AC/DC converter 109 and delivered to the aggregated storage 108A and the amount of aggregated stored energy from the aggregated storage 108A that is converted from DC to AC by the DC to AC inverter or smart inverter 104 for conveyance onto the grid or micro grid 111.

The embodiment of FIG. 2 further illustrates islanding capability 113 of the local distributed energy production and energy storage.

### Energy Storage

Some embodiments of the residential PV modulation systems illustrated in FIGS. 1 and 2 comprise energy storage devices 108, such as one or more lead acid batteries, lithium ion batteries or other battery types, fuel cells, thermal storage device, and the like. In an embodiment, the energy storage device 108 comprises a high capacity battery with a slow discharge, a fast charge battery with a fast discharge for peak demand shaving, or a combination of the both.

### Energy Storage Controller

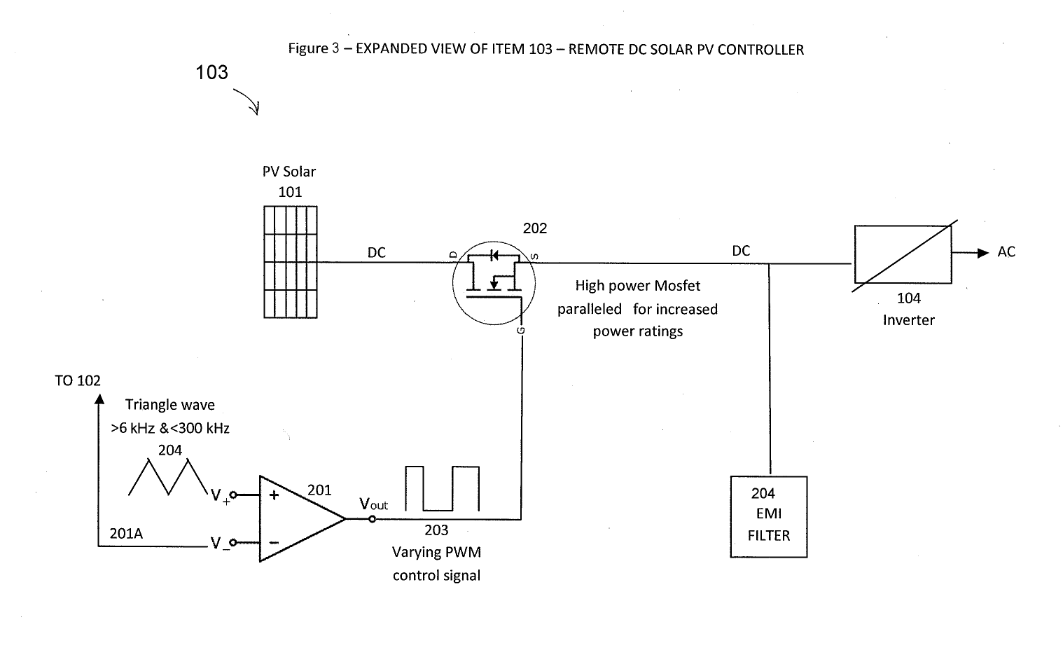

FIG. 3 illustrates an exemplary block diagram of the cloud based pulse-width modulation (PWM) or pulse-duration modulation (PDM) energy storage controller 103. Controller 103 is configured to locally or remotely control and direct the output of a renewable energy generations system, such as, for example, a solar PV system 101, wind system, or energy storage system 108. PWM can be used to vary and control the amount of power delivered to a load from 0-100% without incurring the losses that would result from linear power delivery due to resistance. In an embodiment, the semiconductor switch 202 comprises one or more of a metal-oxide-semiconductor field-effect transistor (MOSFET), an insulated-gate bipolar transistor (IGBT), or the like. Instructions 201A from the energy device controller 102 and triangle wave 204 are input into the PWM signal generator or comparator 201 to generate the PWM control signal 203, which controls the switching of the semiconductor switch 202. The triangle wave 204 comprises a triangular or saw-tooth signal that is greater than approximately 6 KHz and less than approximately 300 KHz. EMI filter 204 provides EMI protection and the DC to AC inverter or smart inverter 104 converts the DC signal to AC.

In an embodiment, the controller 103 comprises a solar PV controller that is integrated with the energy device controller 102 or operatively interconnected to the energy device controller 102. The energy device controller 102 provides energy assessment and communication with a cloud database. The solar PV controller 103 receives instructions 201A from the energy device controller 102 to control and direct the flow of distributed renewable or other energy resources by shedding varying amounts of up to 100% of the energy, storing the energy, or feeding varying amounts from 0-100% of the energy to an interconnected grid or micro grid in a manner that matches the needs of distal interconnected facilities to meet such distal facility energy requirements.

### Energy Device Controller

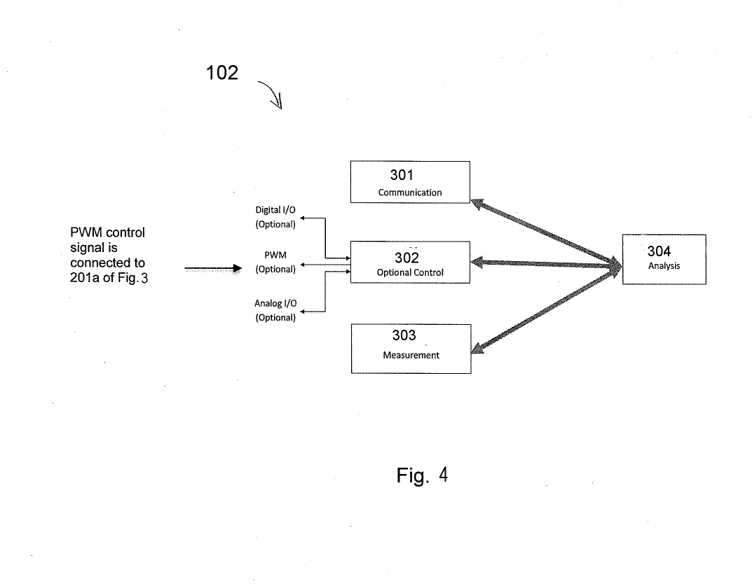

FIG. 4 illustrates an exemplary block diagram of the energy device controller 102 for real time continuous and automated measurement of energy use 303, analysis of energy use 304, control of energy use 302, and communication of energy use 301, energy quality, and metrics. In an embodiment, the energy device controller 102 is configured to communicate with local energy and/or cloud based energy assessment, forecasting, and control systems to control and direct the output of local energy generation resources. In another embodiment, the energy device controller 102 comprises a MelRok Touch device.

In an embodiment, the energy device controller 102 is used to assess energy loads in a facility to develop a profile of energy needs and assess wasted energy in such facility(s). Some embodiments of the energy device controller 102 are configured to perform one or more of:

a. Add local input (handheld or portable or fixed computer) from facility, group of facilities, or network of facilities about interest in using and purchasing renewable energy, stored renewable energy, or lowest cost energy from distal distributed renewable energy resources, energy storage systems, or low cost centralized high carbon energy resources that are interconnected by a grid or micro grid;

b. Communicate information to the cloud about energy needs of facility, group of facilities, or network of facilities;

c. Determine wasted energy and non-essential energy in a facility and direct energy systems to shift or shed wasted energy loads; and

d. Match and direct the flow of low carbon renewable energy resources onto an interconnected grid or micro grid, and pay for aggregation of distal distributed low carbon energy that is brokered through big data cloud matching system and interconnected through a grid or micro grid.

In another embodiment, the energy device controller 102 is used to assess energy loads in a facility that is associated with a distributed energy resource comprising one or more of renewable solar PV, and wind, energy storage, and non-renewable energy sources to develop a profile of energy needs and excess energy supply in a substantially continuous manner. Some embodiments of the energy device controller 102 are configured to perform one or more of:

a. Add input (handheld or portable or fixed computer) from facility that is either associated with or distal to one or more distributed renewable or stored energy resources about interest in selling/supplying such systems excess renewable energy or stored energy on an interconnected grid or micro grid;

b. Communicate information to the cloud about energy needs of facility, group of facilities, or network of facilities;

c. Determine wasted energy and non-essential energy in a facility that is associated with a renewable energy resource or energy storage systems and directs such facility energy systems to shift or shed such wasted energy loads;

d. Determine wasted energy and non-essential energy in a facility that is associated with a renewable energy resource or energy storage systems and directs such energy resources to shed, feed an interconnected grid or micro grid or store such excess renewable energy resource; and

e. Match and direct the flow of low carbon renewable energy resources or energy storage onto an interconnected grid or micro grid, and account for aggregation of distal distributed low carbon energy that is brokered through big data cloud matching system and interconnected through a grid or micro grid.

### Big Data Cloud Processes and Corollary Business Models

In an embodiment, a big data cloud network automatically assesses, forecasts, controls and directs low carbon-emitting energy resources to be automatically “shared” with automated assessment of facility energy usage and loads.

### Renewable Energy Low Carbon Matching System

In another embodiment, a renewable energy low carbon matching system adapts MelRok Internet of Things automated energy assessment, communication, and control of distributed energy resources and loads using MelRok Touch 102 and renewable energy supply PV modulator 103 to work with new cloud based social media shared service models in an automated manner for use in low carbon shared energy networks.

In another embodiment, the renewable energy low carbon matching system is configured to match the automated assessment of energy needs and energy purchasing decisions by facilities with automated assessment of available distributed renewable, storage, or other energy resources that are interconnected on a grid or micro grid in a substantially continuous manner.

### Renewable Energy Sharing Network

In an embodiment, a renewable energy sharing network comprises a big data cloud energy database for matchup and billing of services to users that register an interest in purchasing or selling renewable energy or carbon credits.

In another embodiment, a renewable energy cloud advertising system assesses historical energy-related searches and then automatically inserts advertisements for related goods or services into other searches.

In another embodiment, the renewable energy sharing network uses big data cloud networking techniques to control the flow of energy and bill for energy from a distributed network of renewable energy sources, other energy supplies, or distributed energy storage systems. An embodiment of the energy-sharing network comprises an automated assessment, in real time or in approximately real time, of the amount of energy that is available as excess that can be supplied to meet the aggregated or individual needs for energy. In another embodiment, the energy-sharing network comprises an automated assessment of facility loads that can be streamed to the cloud for matchup with available energy resources. In a further embodiment, the cloud-based energy sharing network-automated assessment of the amount of energy that is available as excess and the automated assessment of facility loads create a social media networking environment.

In an embodiment, the energy-sharing network comprises one or more of:
Automated assessment and communication to big data cloud database about available energy resources (solar, wind, storage, fuel cell, generator, etc.);
Automated assessment and communication to big data cloud database about required energy to meet the load requirements of individual or aggregated facilities;
Automated and dynamic energy resource and energy load database; and
Automated and dynamic control of renewable energy resources or other resources to meet individual or aggregated load requirements.

### Big Data Cloud Assessment, Forecasting, and Low Carbon Energy Control Systems

In an embodiment, big data cloud assessment, forecasting, and low carbon energy control systems comprises the energy device controller 102 and the energy storage controller 103, described above with respect to FIGS. 1A-7. In an embodiment, the energy storage controller 103 utilizes a PWM “intersective” method to control and direct the flow of energy from solar PV, wind, storage or other distributed energy resource to feed local or grid loads, to store energy locally, to store energy at a centralized storage system, to spill excess energy that cannot either be sent to the grid to be absorbed by loads or stored in real time.

### Low Carbon Big Data Cloud Networking and Energy Sharing Engine

A network of energy device controllers 102 and energy storage controllers 103 as shown, for example, in the embodiments illustrated in FIGS. 1-5 can provide the basis for a system to network the supply and use of low carbon energy resources. Such configurations can achieve very large percentages (up to 100%) of energy being supplied by the combination of low carbon distributed energy resources, such as solar PV, wind, and energy storage, streaming energy communication, energy assessment, forecasting, and control of devices 102, 103 and a cloud data base energy control network. In an embodiment, such cloud energy data base control network can register and store both fixed and dynamic information about each centralized or distributed renewable energy resource.

In an embodiment, the cloud data base continuously updates or “learns” by wired or wireless communication with energy device controller 102 information such as, for example:

Fixed size and capacity of local renewable resources and storage;

Dynamic output levels of renewable resources and storage based on local weather conditions, date, time of day, and local energy use requirements;

Use of local renewable generation, storage, or loads in real time based on either automatically measured and “observed schedules and behaviors” of energy loads occurring in facility or residence 106 by the combination of metering device 105 and energy device controller 102;

Local or remote (iPhone/iPad/computer, for example) input about schedules and use of energy for facility or residence 106;

dynamic frequency, phase, voltage and energy supplies or loads on the grid or microgrid to which the renewable energy resources are connected; and

Size, location, and capability of environmentally challenged power plants.

Based on the above information and an assessment of the local or regional behaviors plus the real time dynamic need for energy by aggregated or individual facilities 106, the energy-sharing engine could derive an individualized capability for each distributed renewable resource. Such derived and aggregated capability “assessment” and forecasting of distributed energy resources could then be matched with forecasted needs of the facility loads 106 on the grid or micro grid 111. Knowing this information in real time or approximately real time, enables the energy sharing engine and/or database to automatically control the flow of energy from each distributed renewable resource to contribute some or all of its energy to the grid, to regional storage, to local storage, or to spill excess energy based at least in part on periods of overcapacity on the grid or micro grid. Possible scenarios comprise:

i) Willingness “like/would not like” to feed the grid or micro grid with their local renewable energy resource;

ii) Price that will be paid to owners of renewable energy resources for feeding such energy to the grid or micro grid; and

iii) Proximity to energy loads to accommodate losses in transmission while feeding loads.

Thus, the cloud database can be informed about each renewable energy resource and its real time capability and “willingness” to feed energy to others on the low carbon energy network. In addition, the cloud database also registers preferences by users. For example, preferences such as “Do the users want to use 100% of their energy from renewables and pay a premium or do the users want to use the lowest cost environmentally challenged energy resources to feed their energy use?”. Thus, a business model can be derived from the aggregation and control of energy resources that meet the criteria of feeding each individual facility 106.

As a result, in an embodiment, the cloud database sends communication and control signals to MelRok renewable resource controllers 103 through MelRok Touch 102 devices to control the flow of renewable energy resources and to also establish a payment schedule in kWh to pay owners of renewable energy systems for supplying clean renewable energy to directed loads that are interconnected to a common grid or micro grid.

In another embodiment, a cloud database comprises fixed and dynamic aspects of energy loads and related or unrelated energy resources in facility(s) to match excess dynamic capacity with localized, centralized storage or to feed an interconnected grid or micro grid to meet distal facility energy requirements.

### Energy Marketplace

### Low Carbon Social Media Shared Renewable Energy Service and System

FIG. 1 illustrates an embodiment of a business model used by utilities that control large centralized environmentally challenged base load and spinning reserve or peaker power plants. This architecture is rapidly being supplemented and will ultimately be supplanted by a new overlay technical architecture and business model illustrated in FIG. 2 where, in certain embodiments, hundreds or thousands of distributed energy producing systems and distributed energy storage systems produce power in a fully synchronized, managed, and controlled fashion to serve a diversity of distributed energy loads at facilities or in the form of plug-in electric vehicles (EVs) and plug-in hybrid EVs.

In embodiments described herein, low cost distributed devices (102) assess, control (103), and communicate information from the distributed energy loads, and the distributed renewable energy supply resources, such as solar PV, wind, and storage. Concurrent with assessing, managing, and controlling widely distributed renewable supplies and distributed energy loads is a business model that ingests this information into a cloud based big data energy management system. The cloud based big data energy management system assesses distributed loads and charges for energy usage based on real time use of energy, capacity, and demand, charges for cloud based grid IT systems, and charges for grid maintenance. In an embodiment, the cloud based big data energy management system assesses and pays a “wholesale” rate for each distributed renewable energy supply or storage system that is controlled for its contribution to the aggregated supply of distributed energy that is producing energy to meet load demand.

Some embodiments described herein coordinate assessment, forecast, and management of all connected loads (shifting and shedding techniques) and all renewable supplies (store, feed, or spill) and storage (store, feed, or idle) that are connected to these loads through a grid, microgrid, or other interconnection. The large amount of interconnections coupled with the large amount of data processing in real time or near real time is enabled by the localized placement of energy supply, energy storage, and energy load assessment, communication, and control devices such as the energy device controller 102 illustrated in FIG. 4.

### Matching Distributed Renewable Energy Generation To Loads

In an embodiment, a system is configured to aggregate the control of the energy that is generated by one or more distributed renewable energy resources, such as solar or wind, and distributed energy storage devices, and synchronize the cloud based control of energy supply and loads to match available aggregated distributed energy load requirements in a substantially continuous manner in a facility, group of facilities, or network of facilities.

For example, the aggregate electrical energy that is available from reporting solar PV, wind, or storage, or fuel cells, turbines, or other energy generators is continuously updated into a cloud database with available and forecasted distributed renewable energy resource information. A total or an approximate total of the available aggregated distributed energy resource amount is updated at an update rate with its associated carbon footprint and the amount that sellers of such distributed energy resources are willing to be paid to direct their clean renewable energy resources onto the grid, micro grid or into storage. The update rate can be substantially continuous, daily, hourly, or less than once per hour. Such aggregated renewable energy production is also forecasted in real time or near real time in the database as to reliability and availability of renewable power for a period of time where the period of time can be approximately 60 minutes, five minutes, one minute, less than 60 minutes, more than 60 minutes, more than 5 minutes, less than five minutes, or the like. This aggregated amount of clean, low carbon, renewable energy is then posted to a database for buyers to register a bid to purchase this energy in amounts of money or other fungible barter mechanism that buyer is willing to pay for watts, kilowatts, megawatts, or gigawatts of clean renewable energy in real time and for a time frame, such as, for example, the next 60 minutes, any 60 minutes, a time period greater than 60 minutes, a time period less than 60 minutes, a future time period. When a corresponding purchase order is made by a click of the mouse or a touch of a screen, for example, such aggregated energy and carbon footprint is purchased and allocated to the purchasing entity and an automated payment takes place by deducting said amount from the purchaser in a central cloud based clearinghouse. Within a period of days or weeks, or an appropriate settlement period, the sellers of renewable energy are paid for the energy that they have contracted to sell through the cloud database.

In the case of the interconnected grid or micro grid, the electrons that are sent by a distributed renewable energy resource may or may not be those same electrons that are consumed at a distal point by the buyer of such energy. Instead, the accounting of renewable energy electrons are “banked” in the database and may be in practice actually be used by a source local to the generating point. The electrical energy on a grid or microgrid is fungible and interchangeable. It is the amount and bulk purchase of aggregated renewable sources of fungible electrons that is purchased and sold through the cloud database. It is the banking of the renewable energy credits and energy that are associated with the actual delivery of watts, kilowatts, megawatts, or gigawatts onto a grid or micro grid that has the greatest value.

Decoupled Control Messaging from Feedback

In conventional power grids dominated by centralized generation, disruptions in generation or increases in demand are compensated by increased or decreased generation at centralized power plants. The detection of the fault and the remedial actions are relatively localized. The measurement of the power output, the assessment of the control actions needed, and the execution of the control action are conducted by systems that are typically co-located or with direct communication channels between them.

With the evolution of power grids into distributed grids, compensation of variations in generation or demand will require the fast management of a large number of devices spread across a geographic area. The variations could be due to fluctuations in the output of distributed resources, renewable resources, and conventional power plants, as a result of failures in generation, failure in transmission, acts of terror, sabotage, vandalism or due large or sudden changes in energy consumption. In a distributed energy resources environment, large distances may exist between the one or more processors assessing the state of the grid, one or more processors implementing a control algorithm and initiating control commands, and the one or more actuators executing the control command. Two way communication channels, whether IP-based, RF based, hard wired, or other, suffer amongst other things from latency issues, limited geographic reach, limited number of devices that can be reached at one time, and security vulnerability. Use of such communication channels compromise the stability and security of the power grid.

The methods and systems described here propose for the first time decoupling the communication channels used for sending instant information messages and control instructions to the distributed resources, from the communication channels used in the return path to relay measurements and status from the distributed resources.

In some embodiments, FM, AM, VHF, UHF, and other broadcast technologies are used to deliver secure and instant communication to an unlimited number of distributed resources in a power grid or microgrid. These broadcast technologies have inherent security, reliability, speed, range, and reach advantages over other wireless and RF two way communication technologies such as 900 MHz systems, 2.4 GHz systems, 4G networks, microwave communication, and other wireless and RF systems.

The messaging and control communication channels can be used to send and receive pricing information, grid status information, weather information, algorithms, constants, metrics, configuration settings, firmware updates, security encryption keys, control instructions, market conditions, financial metrics, and other data to and from the distributed energy resources. The distributed resources can include thermostats, appliances, energy management systems, power inverters, power modulators, energy storage controllers, water sprinklers, chillers, exhaust fans, pumps, compressors, air handlers, space heaters, water heaters, boilers, fuel cells, energy meters, lighting controllers, transformers, computers, cell phones, energy trading platforms, generators, capacitors, inductors, storage devices, air valves, and other resources.

### Distributed Spinning Reserves

In an embodiment, the distributed resources are managed such as to match the behavior of a conventional spinning reserves generator. A spinning generator is a power generator that is online and spinning but not connected to the grid, hence no load is generated. Spinning reserves are used to compensate for unexpected generation and transmission outages, and can be brought online within seconds to maintain system frequency. It is expected that the dynamic nature of the renewable resources being deployed across power grids will amplify the need for spinning reserves. Conventional spinning reserves however have a high carbon footprint because of the fuel used to keep the generators spinning while no power is being produced. These emissions and costly sources of power can be avoided by using the fast and secure messaging platform described here to send instructions to a portfolio of distributed generation and storage systems to allow for the fast dumping of aggregate power into the grid, in a manner somehow consistent with the way spinning reserves operate. The distributed resources used for spinning reserves can include fast charge and discharge batteries, flywheel storage systems, loads that can be shed within milliseconds or seconds, and other resources. The impact of the associated surge (or reduction) in power introduced to the grid can be measured at select locations (such as substations, utility meters, centralized power plants, interconnection points, distributed resources, etc.) and the information sent back via IP-based or other communication channels.

In other embodiments, the distributed resources are managed to match the behavior of a load following power plant, a base power plant, a load following plant, a grid voltage balancing network, or a grid inertia balancing system.

### Platform for Routing Power Through a Grid

In other embodiments, the platform is used to route power through a grid from one or more sources to one or more energy consuming or storage devices. The routing is done by sending secure and instant messages to switching devices along the grid using the secure messaging platform described here. Measurements at different locations along the grid, in addition to the status of the switches and other equipment along the grid, are sent back to the grid management controller or software. The source and destination resources can be downstream the same substation, or across multiple substations.

### Platform for Containing Power Outages in a Grid

In other embodiments, the platform is used to contain power outages in a grid by disconnecting resources that add stress to the grid during an outage and by re-routing power from energy resources in other parts of the grid that may have spare power generation capacity.

### Platform to Secure Control of a Power Grid

The increased reliance on distributed resources in power grids requires reliance on communications amongst the resources and communication between the resources and one or more central processing unit or software. This increased reliance on communications between devices increases the vulnerability of the grid to security incursions through these communication channels. Such incursions can result in the hijacking of the resources for terrorism, sabotage, theft, espionage, ransom, or any other malicious or non malicious intent. This is similar to the hacking incidents that occur on a regular basis, where corporations find themselves the target of hackers who breach their data and control systems.

In one embodiment, the device that controls the grid is equipped with two communication channels. A first channel receives instructions through one protocol and/or physical interface, and the second channel receives instructions through a second protocol and/or physical interface. The physical interfaces could be any of FM, AM, VHF, UHF, 900 MHz, 2.4 GHz, 5 GHz, wired Ethernet communication, wired serial communication, wired parallel communication, WiFi, WiMax, ZigBee, dry contacts, or other wired or wireless interface. The communication protocols could be any of WiSUN, ModBus, BACnet, Lonworks, IPv6, IPv4, html, XMMP, XML, JSON, OpenADR, ZigBee SEP, or other. The advantage of broadcast technologies such as FM, AM, VHF, UHF is that they cover a wide geographic area and are inherently very secure where compromising the signal requires physical devices to be placed at a geographic proximity to the resource that is targeted by the broadcast communication.

In one embodiment, the two instructions are passed through the equivalent of an AND logic gate to ensure that both instructions have to be received in order for the action to be taken.

In one embodiment, the two instructions contain pieces of an encryption security key that is needed to decode any of the commands sent over any of the channels.

In one embodiment, one of the channels is an FM, AM, VHF, UHF or other broadcast technology that can securely reach millions of devices within milliseconds.

In one embodiment, one of the channels is an Ethernet or other interface that has capacity to transmit large number of data approximately every second.

In one embodiment, the encryption key is sent over a secure broadcast network to one channel while the data transmission is done over a high bandwidth network to the second channel.

In one embodiment, one channel is enabled in response to a cyber-attack on the power grid to prevent propagation of the cyber-attack through the grid and to reclaim control of any resource that has been compromised. Control is reclaimed by having the resource respond to instructions sent over one channel to ignore instructions received over a second channel or to ignore one or more sources of instructions sent to the other channel.

In one embodiment, one channel is used to send a list of approved IP addresses, or other addresses identifying the source of the communication packet, to the distributed resource or other device on the grid. The list can be updated at regular or irregular intervals. When a security breach is detected or suspected, a new list can be broadcast to the distributed resources and other devices and facilities on the grid or microgrid.

In one embodiment, control signals, information, measurements, status or other data is communicated over one channel to devices and distributed resources. Such control signals could be ON/OFF signals or power modulation levels and signals to set the output of a distributed resource or dictate the level of output that is directed to the grid, to an energy storage system, or from and to any other energy resource. The second channel is used to send instructions as to whether one or more resource or device is enabled or not.

### Platform for Managing a Power Grid During an Outage of its Primary Communication Network

In one embodiment, one of the channels is used as a primary communication channel and the second channel can be used as a backup communication channel. The primary channel can use a technology that has the capacity to transmit large amounts of data approximately every second, in one or two directions. The second channel can use a technology that has the capacity to transmit small amounts of data approximately every second, in one or two directions.

In one embodiment, one channel is used for primary communications while the second channel is used for sending emergency signals to one or more devices and resources along the grid. This ensures bandwidth to be available for the broadcast of emergency information or control signal to one or more resource or device on the grid, microgrid, or facility.

In an embodiment, a system uses a first broadcasting technology to securely and instantly send information, messages, and control instructions to distributed resources across a power grid or microgrid. The information, messages, and control instructions can be based on one or more of spinning reserves, power routing, microgrid islanding, and building islanding. The system can use a second communication technology, such as, for example, RF, cellular, IP-based communication technology, and the like, for a return path.

In an embodiment, the system uses two or more independent paths to confirm a control command sent to grid systems. The first command is sent through FM, AM, VHF, UHF, or other local broadcast network, while the second command is sent using a second communication path such as Ethernet, cellular, ZigBee, 900 MHz, or other. The dual system allows the implementation of security (inherent to the local broadcast network) features along with the high bandwidth for data transmission provided by the other communication platform.

In another embodiment, the system uses a secure communication platform, components of, and distributed energy resources, in a power grid to route the power from a generation resource at one or more locations, to an energy consuming (or storing) device at one or more other locations.

### Aggregated Cloud Based Control of Distributed Renewable Energy Supply and Storage

In an embodiment, a system of energy assessment devices (102) with PV energy controllers (103) is configured to automatically transmit availability and forecasted energy availability from a distal and remote group of clean renewable energy resources to a cloud database. The cloud database comprises information (calculated or derived) about the amount of aggregated distributed energy resources, renewable credits, and price that such energy is offered wholesale for sale. The cloud database embodies and comprises control strategies for distributed renewable energy supplies and energy storage and is configured to charge buyers a retail amount for such energy and for the maintenance and synchronized control of sufficient energy resources and transmission facilities to power individual or an aggregate of distributed energy loads in a facility, group of facilities, or network of facilities in a substantially continuous manner. In another embodiment, a system is configured to aggregate renewable energy credits. In a further embodiment, a system is configured to aggregate, shift or shed energy loads in a manner that is synchronized with available aggregated energy supplies and energy storage supplies in a substantially continuous manner.

### Other Embodiments

In an embodiment, a novel grid-tied renewable energy management system comprises devices for controlling distributed renewable energy resources and energy storage with synchronized energy load control. In another embodiment, a system of open source devices and big data cloud processing measures, assesses, synchronizes, manages, and controls individual and aggregated distributed renewable energy supplies, such as solar and wind, energy storage, and energy loads. In another embodiment, a business model utilizes the system of open source devices and big data cloud processing that measures, assesses, synchronizes, manages, and controls individual and aggregated distributed renewable energy supplies, such as solar and wind, energy storage, and energy loads.

In an embodiment, open source data cloud processing is used to synchronize distributed renewable energy supply and distributed energy load data across distributed facilities/locations. The energy data is used to determine, define, and transmit energy management and control signals to individual and groups of distributed energy supply, energy storage, and energy load control devices. In an embodiment, the cloud processing comprises data processing engines, such as for example, Hbase, a bigtable-like structured storage that runs on top of Hadoop HDFS, and the like.

In an embodiment, a system controls energy loads associated with a facility, group of facilities, or network of facilities in substantially real time to match the real time available supply of one or more distributed renewable and non-renewable energy resources and energy storage, onto the grid, onto a microgrid, in a grid substation; using wired conveyance, and using wireless conveyance.

### Terminology

The various illustrative logical blocks, modules, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics, or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments of the inventions described herein may be embodied within a form that does not provide all of the features and benefits set forth herein, as some features may be used or practiced separately from others.

What is claimed is:

1. A method comprising using a platform to send communications and instructions to one or more distributed resources on one or more of an electrical grid, microgrid, and facility to direct a flow of power from one or more power sources to one or more energy consuming devices.

2. A system comprising a first platform to send communications and instructions to one or more distributed resources on one or more of an electrical grid, microgrid, and facility to direct a flow of power from one or more power sources to one or more energy consuming devices.

3. The system of claim 2 wherein the first platform comprises a first broadcast technology.

4. The system of claim 3 further comprising an apparatus that implements a return path from the one or more power sources and the one or more energy consuming devices to the first platform.

5. The system of claim 4 wherein the return path utilizes one or more of radio frequency (RF) communications, cellular communications, and Internet Protocol (IP) based communications.

6. The system of claim 1 further comprising two or more independent paths to confirm a control command sent to a grid system.

7. The system of claim 6 wherein the control command is sent through a first path comprising one or more of an FM, AM, VHF, and UHF broadcast network.

8. The system of claim 7 wherein a confirmation command is sent through a second path different from the first path.

9. The system of claim 8 wherein the second path uses one or more, comprising one or more of an Ethernet, cellular, ZigBee, and 900 MHz communication platform.

10. The system of claim 9 wherein the second path implements security features and the first path provides high bandwidth for data transmission.
